(19) United States
(12) Patent Application Publication
(10) Pub. No.: US 2004/0015851 A1
(43) Pub. Date: Jan. 22, 2004

(54) Method and system for maintaining data integrity for transactional resources

(76) Inventors: Matthew J. Newhook, St. John's (CA); Brent A. Eagles, Torbay (CA)

Correspondence Address: LACASSE & ASSOCIATES, LLC, 1725 DUKE STREET, SUITE 650, ALEXANDRIA, VA, 22314, US

(21) Appl. No.: 10/095,989

(22) Filed: Mar. 11, 2002

Related U.S. Application Data
(60) Provisional application No. 60/274,730, filed on Mar. 10, 2001.

(51) Int. Cl. G06F 9/44

(52) U.S. Cl. 717/116

(57) ABSTRACT

A simple, efficient method and system for creating a transactional resource that it is easily verifiable is provided by the present invention. In one aspect, the invention comprises a method and system for implementing, with objects, operations that modify state that must be recovered in the event of a rollback. A preferred design is described, along with details regarding resource management, how operations should be constructed and performed and how the operations should be rolled back.

In another aspect, the present invention is directed to a method of and structure for interaction between resource managers and their corresponding resources. If a resource manager does not have sufficient knowledge of the underlying processes inherent in operations on a resource, the resource itself takes on some of the responsibilities. In another aspect, the present invention addresses a structure for implementing such a resource and the creation of a specialized resource manager to integrate with an existing system. These systems and methods have the added advantage of being applicable to all transaction types (short, immediate, or long running transactions) and system sizes (small, embedded systems to large-scale enterprise systems).

### CROSS REFERENCE TO RELATED APPLICATIONS

This application is related to the U.S. provisional application No. 60/274,730 filed on Mar. 10, 2001 by Matthew J. Newhook and Brent A. Eagles and entitled “METHOD AND SYSTEM FOR MAINTAINING DATA INTEGRITY FOR TRANSACTIONAL RESOURCES,” which is incorporated herein by reference in its entirety.

### FIELD OF THE INVENTION

The present invention relates to the field of electronic transaction processing.

### BACKGROUND OF THE INVENTION

In typical electronic transaction processing, one or more resources are registered with a transaction and perform operations. If the transaction is aborted, these resources must be returned to the state they were in before they joined the transaction. If the transaction succeeds, then each resource is committed and its state remains constant until further operations are performed on it. Electronic transaction processing is described in “Transaction Processing: Concepts and Techniques,” by Jim Gray and Andreas Reuters (Morgan Kaufman, 1993), and in “Principles of Transaction Processing,” by Philip A. Bernstein and Eric Newcomer (Morgan Kaufman 1997). Both of the foregoing books are incorporated herein in their entireties by reference.

A typical transaction involving operations on two resources is schematically illustrated in FIG. 1. The transaction begins at time to. Subsequently, a first resource, R₀, is added to the transaction, and after it is added, operations are performed on R₀. Then a second resource, R₁, is added, and operations are performed on R₁. After all operations on all resources are performed (or attempted), the transaction resources are prepared to commit the transaction. If all resources signal that the preparation is successful and they are ready to commit, the transaction is committed. Otherwise, the transaction is rolled back, and the operations are undone, restoring the resources to their original condition.

A simple schematic illustration of programs involved a typical electronic transaction is shown in FIG. 2 (see Gray, et al. FIG. 1.8.) The execution of the transaction 201 occurs under the control of the transaction manager, and is spread among one or more application programs 202 and 203, and one or more resource managers 204. As described in Gray, et al., the role of a resource manager 204 is to “perform work on behalf of the transaction, keep lists of the changes they have made to objects,” and to “record both the old and the new value of the object”. Gray, et al. at 19. This document is directed to the activities of resource managers as well as the objects that are acted on by the resource managers, called resources. Database systems, persistent programming languages and windowing systems are given by Gray et al. as examples of typical resource managers. Gray, et al. at 17.

A traditional approach for implementing rollback due to an aborted transaction is to store a copy of a resource's state in volatile or non-volatile memory when it joins the transaction. The resource implements rollback by using the stored state to recover its state. It may also use the stored state to reconcile changes and perform clean-up operations if necessary. However, implementing clean up to recover from operations that allocate resources, establish connections, etc., can be difficult and is often error-prone. It requires discovery of the differences between the current volatile state and the pre-transactional state and determining the appropriate operations to restore the pre-transactional state without resource “leakage” (e.g., object deactivation, restoring state in non-transactional participants, destroying connections, etc.). This technique is also very costly in terms of memory and time if the resource is modifying complex data.

The interaction of resource managers and the resources that the resource manager acts on is not described by Gray, et al., but Gray implies that the resource manager has sufficient knowledge about the resources and the types of operations and data that are performed to store and manage state changes during the course of a transaction. This is not always the case in modern general-purpose transaction systems or in systems that need to implement traditional transaction semantics without the presence of a full-scale transaction processing system or without an appropriate transaction-aware resource manager.

Further, while there are many existing systems that provide traditional transactional processing system facilities, system developers often require similar semantics in the absence of pre-existing systems or tools. This is often the case in embedded systems or non-transaction-aware programming languages (e.g. C++). Problems can also arise when integrating software into a transactional environment. Traditional methods of transaction processing may be inappropriate in the presence of complex state, data that has complex runtime representation, small changes to data result in complex reactions, etc.

Developing a transaction-aware resource is a non-trivial task. Implementing rollback functionality can be difficult and costly, especially when dealing with complex data and data that is partially modifiable through multiple, disjoint activities. A simple, efficient method for creating a transactional resource that it is easily verifiable is needed when developing critical and real-time systems.

### SUMMARY OF THE INVENTION

A simple, efficient method and system for creating a transactional resource that it is easily verifiable is provided by the present invention. In one aspect, the invention comprises a method and system for implementing, with objects, operations that modify state that must be recovered in the event of a rollback. A preferred design is described, along with details regarding resource management, how operations should be constructed and performed and how the operations should be rolled back. In another aspect, the present invention is directed to a method of and structure for interaction between resource managers and their corresponding resources. If a resource manager does not have sufficient knowledge of the underlying processes inherent in operations on a resource, the resource itself takes on some of the responsibilities. In another aspect, the present invention addresses a structure for implementing such a resource and the creation of a specialized resource manager to integrate with an existing system. These systems and methods have the added advantage of being applicable to all transaction types (short, immediate, or long running transactions) and system sizes (small, embedded systems to large-scale enterprise systems).

Using object-oriented or object-based programming techniques, the expense and difficulty of recovery from aborted transactions can be reduced. Preferably, objects are used to encapsulate operations that modify the state of a resource. Operation objects remember the changes that they make to resources and this information is used to implement a very precise and direct rollback mechanism. In a preferred embodiment, operations that modify a resource's state are encapsulated in a class. When the resource must perform an operation that will modify its state while in a transaction, the resource creates an instance of the appropriate class, executes it, stores it in list of completed operations and continues.

In one aspect, the invention comprises a data storage device comprising data representing one or more computer programs that perform an operation that causes a reversible change on the state of a resource object, comprising: a resource module comprising computer program logic, the resource module being configured to respond to a request to perform an operation that changes the state of the resource module by creating an instance of a module comprising the operation and a method for reversing the effects of the operation on the state of the resource module, requesting the instance to perform the operation, and storing the instance; the resource module being further configured to respond to a request to undo the operation by calling the method for reversing the effects of the operation.

In various related aspects, the resource module is preferably a software object, and the instance is preferably a an instance of an object encapsulating the operation. In other related aspects, the class encapsulating the operation is a subclass of a base class, the base class having an interface for performing an operation encapsulated by an instance of the base class, and an interface for reversing the effects of the operation encapsulated by the base class; or the resource object is an instance of a subclass of a base resource class having an interface for managing operations and reversing the effects of operations; or the class encapsulating the operation is a subclass of a base operation class, the base operation class having at least one an interface configured to respond to an interface of the base resource class; or the instance is configured to return a value in response to a call to perform the operation encapsulated by the instance. In still other related aspects, the class encapsulating the operation defines an accessor method that, when called, provides a value set by the instance when the operation encapsulated by the class is performed; or the class encapsulating the operation defines a non-private variable to store a value set by the instance when the operation encapsulated by the class is performed; or the instance is configured to receive a variable with a call to perform the operation encapsulated by the instance and to set the value of the variable when the operation encapsulated by the class is performed; or the instance is stored after the instance has performed the operation; or the resource is configured to receive a request to commit a transaction, and to release resources associated with the instance in response to the request to commit, or the instance is created by a factory object; or the instance is stored in a list.

In still another aspect, the invention comprises a data storage device comprising data representing a transactional resource, comprising: a transactional resource object encapsulating computer program logic, the resource object being configured for inclusion in a transaction; and the transactional resource object being further configured to respond to a request to perform one or more operations that change the state of the resource object by, for each of the one or more operations: creating an instance of a class encapsulating the operation and a method for reversing the effects of the operation on the state of the resource object, requesting the instance to perform the operation, and storing the instance;

the transactional resource object being further configured to respond to a request to rollback the transaction by retrieving each instance, and invoking on each instance the method for reversing the effects of the operation encapsulated by that instance on the state of the resource object.

In related aspects, the transactional resource object is preferably further configured to receive a request to prepare to commit the transaction, and to provide in response a message indicating whether the transactional resource object is prepared to commit the transaction; or the transactional resource is further configured to store the instance after the instance has been executed; or the transactional resource is further configured to store the instance in a list; or the transactional resource object is further configured to invoke the method of reversing the effects of the operation encapsulated by each instance in a sequence that is the reverse of the sequence in which each instance was requested to perform the operation encapsulated by the instance.

### BRIEF DESCRIPTION OF THE DRAWINGS

FIG. 1 schematically depicts a transaction sequence.

FIG. 2 schematically depicts a set of program entities involved in a transaction.

FIG. 3 schematically depicts a Resource-Operation system.

FIG. 4 schematically depicts a sequence of activities of a Resource-Operation system.

FIG. 5 schematically depicts a call to a commit( ) method of an Operation object.

FIG. 6 schematically depicts calls to rollback( ) and delete( ) methods of an Operation object.

FIG. 7 is a listing of an example transaction system.

FIG. 8 is a listing of the transaction system of FIG. 7 after conversion to a Resource-Operation system.

FIG. 9 schematically depicts the Gamma Command pattern.

FIG. 10 schematically depicts a sequence of activities of a Command pattern.

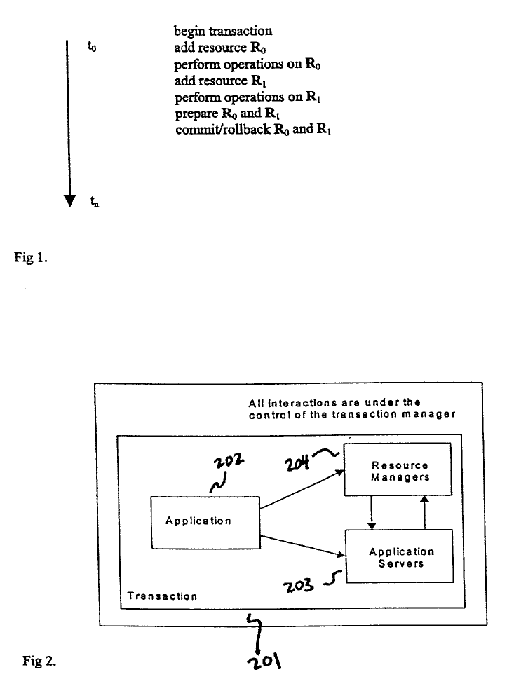

### DETAILED DESCRIPTION OF THE INVENTION

In a preferred embodiment, each operation that modifies a resource's state is encapsulated in a class. When the resource must perform an operation that will modify the resource's state while in a transaction, the resource creates an instance of the class encapsulating the operation, executes the instance, stores the instance in list of completed operations. The operation object may contain all of the logic for performing the operation, or it may share some of the logic with the resource being acted on. The list may be any data structure capable of preserving information of the order in which the instances were executed or added to the data structure.

In a distributed object environment, the operation object may be local to the resource (in-process) or it may require Remote Procedure Calls (RPC's) and/or remote object lifecycle management (e.g. operations encapsulated in COM objects). Note also that the resource provides an opportunity to isolate the operation object from any resource managers acting on it. This means the implementation of the operations on the resource are preferably independent from the overall transaction environment, providing more portability and flexibility in diverse or changing transaction processing systems. There is also the added benefit that if a resource wants to perform the same operation outside of a transaction, it can simply create an instance of the appropriate class and do so. The operations encapsulated in the class may be used whether transactional behavior is required or not.

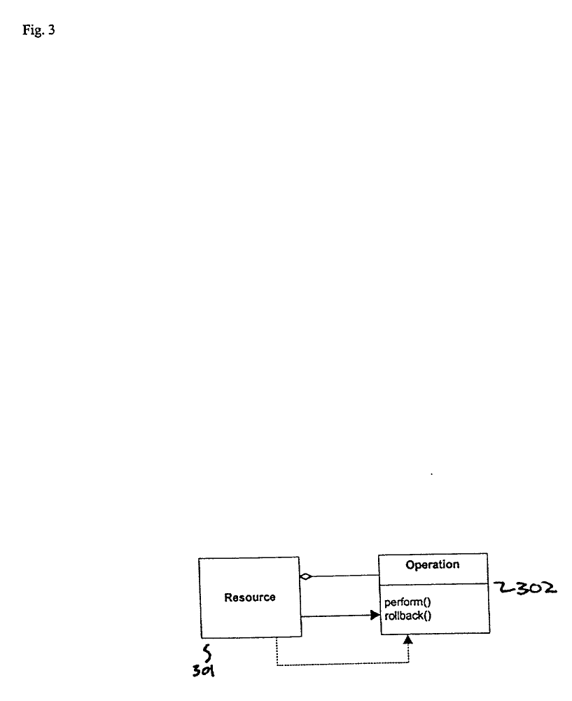

An example preferred embodiment of one aspect of the present invention is schematically illustrated using Unified Modeling Language (UML) in FIG. 3. A Resource class 301 aggregates one or more objects of an Operation class 302. The Operation class 302 comprises a perform( ) method for causing a state-changing operation to be performed on the resource encapsulated by the Resource class, and further comprises a rollback( ) method for rolling back, or undoing, the state change caused by the operation performed when the perform( ) method was previously called. Other names for the classes and methods, specific to the application, would typically be used.

Several preferred variations may depend on the nature of the resource or resources and operations to be performed on them. If many different types of operations are to be performed on a resource, a base class may be created for these operations and all operations my be implemented as specializations or subclasses of the base class. If many resources that use this design are being implemented, the implementation for managing operations and rollback could be moved into a base class. If a base class is used for these resources, it may be necessary to create a base class for all classes that implement operations and that are to be used by the resource base class.

If the operation being performed by the resource requires a return type, the class implementing the operation is preferably extended to provide an accessor method to extract the value(s) to be returned. Alternatively, a reference to a variable may be passed to the operation.

If many operations are to be performed on a resource in a given transaction, the resource preferably keep a list of the completed operations so that it can roll all of them back if the transaction is aborted.

In one alternative embodiment, the interface of the operation class may be extended to service commit or rollback requests directly.

If many operations are implemented and/or the resource provides a dispatch type interface, an operation factory might be used to create the operation instances.

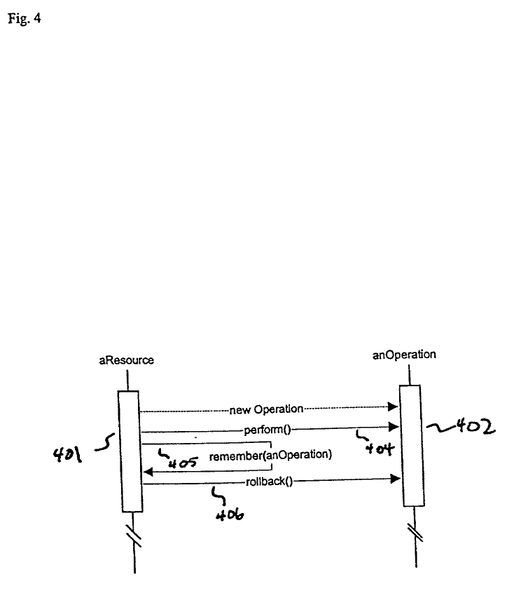

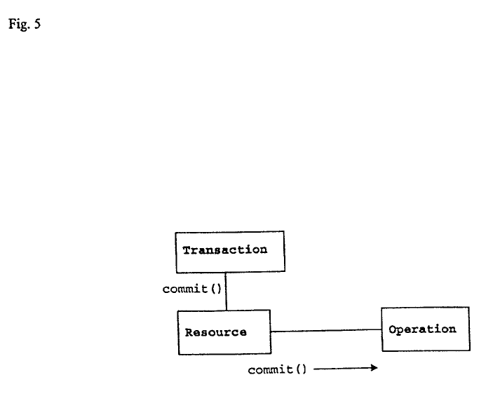

One preferred sequence of activities of a the FIG. 3 embodiment is schematically illustrated in FIG. 4. To perform a state-changing operation, an instance aResource 401 of Resource class 301 creates a new instance anOperation 402 of Operation class 302 that encapsulates the desired operation. The Resource instance aResource 401 then executes the Operation instance anOperation 402 by calling the perform( ) method 404 of anOperation 402. The resource then remembers/stores 405 anOperation 402 to permit the resource to be subsequently rolled back, if necessary. By subsequently invoking the rollback( ) method 406 of the remembered instance anOperation 402, aResource 401 requests the instance anOperation 402 to reverse the effect of the operation encapsulated by anOperation 402, thereby restoring the resource encapsulated by the instance aResource 401 to the state the resource was in before the operation encapsulated by the instance anOperation 402 was performed.

When a resource is committed, there may be nothing left to do except release memory allocated to the operations. However, in some cases, the resource may need to perform some additional actions that are associated with the encapsulated operation when it receives the commit call from the transaction system. These additional actions are often directly related to activities performed by the operation objects. Therefore, in one preferred embodiment, commit operations are implemented in the respective operation objects as illustrated in FIG. 5. If the resource will be participating in a transaction system that implements a two phase commit protocol, the operation object may implement operations relevant to its task to prepare the resource for an eventual commit.

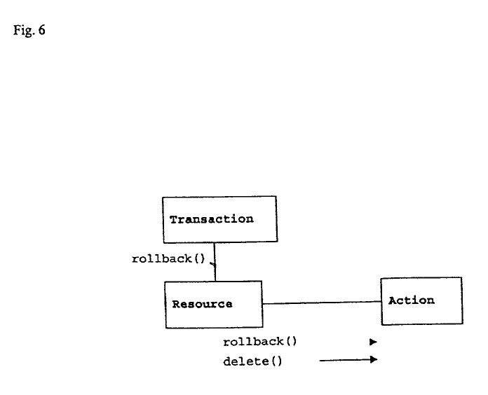

When the transaction is committed, the resource simply needs to iterate through the list of remembered operations and call the appropriate functions. Similarly, when the resource is rolled back, the resource calls a rollback( ) method on each instance of each Operation class in the transaction upon which the resource has called a perform( ) method, then releases memory allocated to the operations, as schematically illustrated in FIG. 6. When being rolled back, the resource calls the rollback( ) methods on the Operation instances in the reverse of the order in which Operation instances were created and their perform( ) methods called.

The following preferred constraints facilitate maintenance of data integrity:

1. With the exception of operations that create, allocate or destroy resources, operation objects are preferably only permitted to modify the resource which created them and/or resources that are otherwise associated with the resource that created them.

2. The order in which operations are rolled back is preferably the reverse of the order in which they were performed.

3. The resource provides the mechanism for invoking the rollback method on all completed operations.

4. Operations that result in an exception and will therefore cause the transaction to rollback must undo changes they have made before causing the transaction to rollback.

5. Memory allocated to operations must be recovered by the resource upon commit or rollback.

6. Resources that are modified by a transaction typically may only participate in one such transaction at a time. Therefore, in such transactions, any records of completed operations should not be modified by agents outside of the context of the current transaction. Generally, such a resource and its list of operations is exclusive to the transaction modifying the resource.

7. Operations must be performed before they are remembered.

The order in which the Operation is performed and remembered is of particular importance. A more traditional approach would be to remember the operation before it is performed. This can create difficulties when implementing transactional systems. If an operation is remembered before it is performed and an exceptional condition occurs while performing the operation, the transaction would abort and the rollback method would eventually be called. This does not typically pose a problem for operations that have completed, but operations that are partially complete would need to maintain detailed state information of how much of the operation was completed. Furthermore, remembering the resource before execution precludes attempting recovery and resumption without aborting the transaction. Since it is typically more straightforward to handle exceptional conditions within the context of the operations that caused it, performing the operation before it is stored simplifies implementing recovery from partial completion within the operation. Rollback performance is also typically improved as there is no need for heuristics for handling partially completed operations.

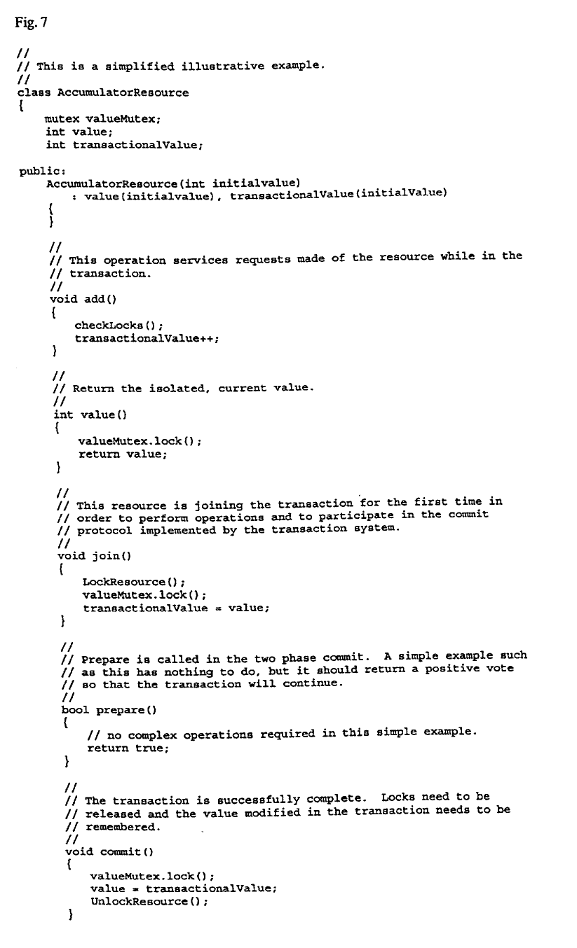

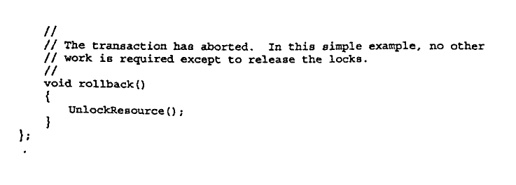

A simplified example of a class that implements some common interfaces for participating in a transaction is set forth in C++ in FIG. 7. For brevity, some existing functionality is assumed of the runtime environment, such as the existence of a suitable transaction-aware mutex locking system.

One preferred method of converting the example of FIG. 7 to employ the Resource-Operation system in accordance with this document is as follows:

1. Implement an operation class for the add request (AddOperation),

2. define a type for a list of these operations to permit multiple add requests (Operations),

3. change the add( ) method on the AccumulatorResource instance to create a new AddOperation object, invoke it and add it to its list of completed Operations,

4. add code to the commit( ) method to release memory allocated for the resources, and

5. add code to the rollback( ) method to traverse the list of completed operations in reverse order and to release memory allocated for the operations.

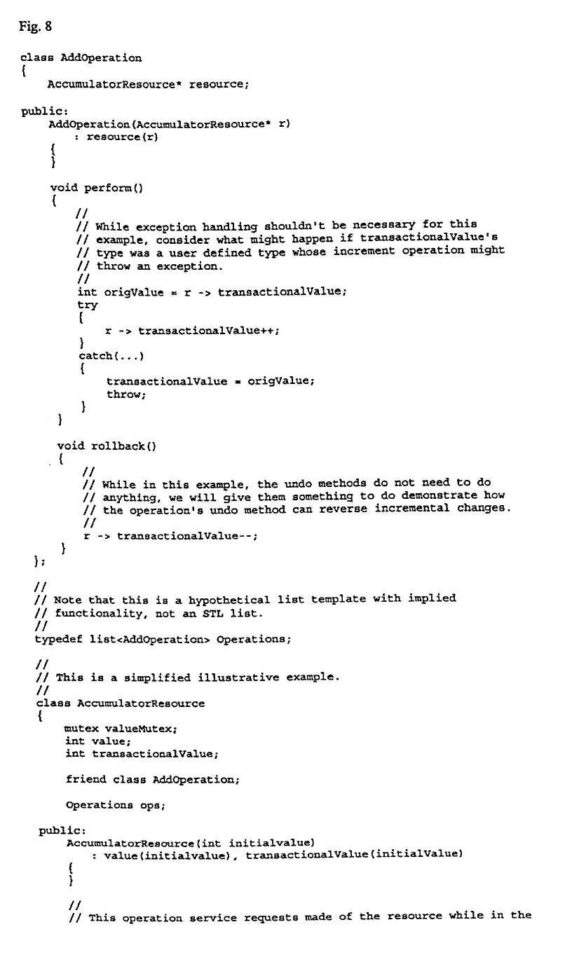

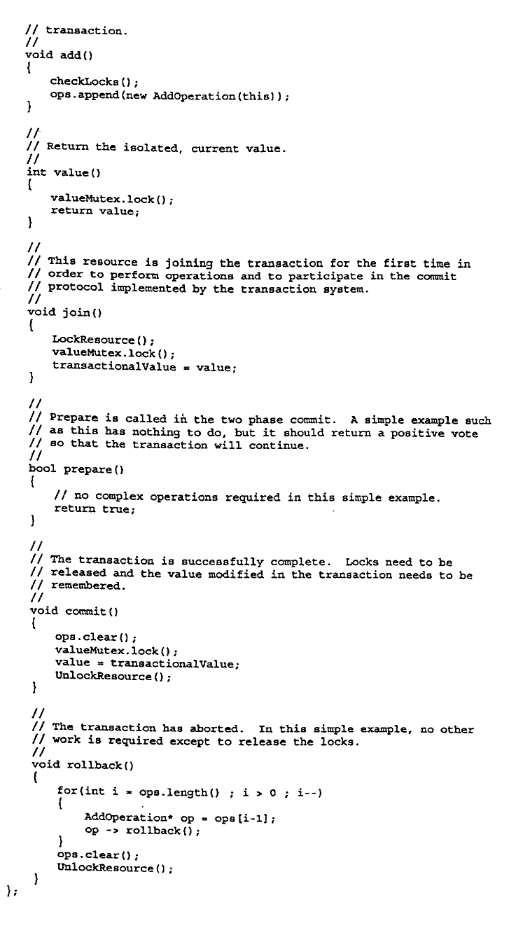

One resulting simplified example preferred system is set forth in C++ in FIG. 8. Those of skill in the art will recognize that a wide variety of implementations of the system and method described in this document are possible, and are not limited to the languages or implementations set forth to exemplify the invention.

The approach described above can be employed to advantage in a wide variety of environments, including, without limitation, the following:

Embedded systems. Full-fledged transaction processing systems may not be available on embedded platforms. These systems often do not have non-volatile memory as well.

Integration of systems without ‘native’ support for transactions into transaction processing systems.

System configuration systems. Small changes to data often have wide reaching affects.

Data transfer systems where data is not opaque and is acted on by the system or causes behavioral changes to the system. (e.g. embedded configuration messages, quality of service properties, etc.)

Publish/subscribe systems where subscribers need notification of incremental updates on data.

Data on disk is represented by large and/or complex data structures in memory.

Small systems that must comply with the well-documented ACID properties, but do not have an existing transaction processing system or where one would be inappropriate (e.g. an old DOS platforms without significant CPU or disk)

On-Line Analytical Processing tools and other systems for “What-if” analysis of complex data.

The approach described above is significantly different than a conventional request encapsulation technique described as the Command pattern in “Design Patterns: Elements of Reusable Object Oriented Software” by Gamma et al. (Addison Wesley, 1995). As stated by Gamma, et al., the Command Design pattern is used to “Encapsulate a request as an object, thereby letting you parameterize clients with different requests, queue or log requests, and support undoable operations.” Gamma, et al. at 233.

Unlike the Gamma Command pattern, the present design encapsulates operations on an object participating in a transaction so that rollback is more easily implemented. If many operations are performed on an object, during a transaction, the object is responsible for remembering the operations that have been performed and rolling back the completed operations.

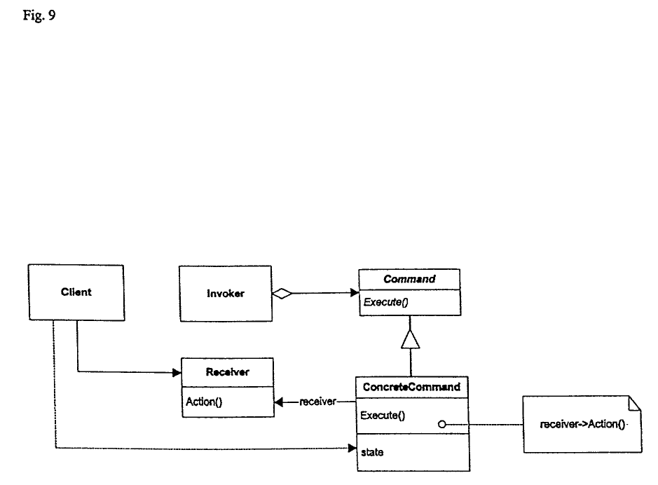

UML class diagrams for the Command Pattern and for the present system are set forth in FIG. 9 (see Gamma, et al. at 236). Comparing FIG. 9 to FIG. 3 demonstrates that there are far fewer classes and relationships in the Resource-Operation system of FIG. 3 than in the Gamma Command Pattern of FIG. 9. The Resource-Operation design does not imply any unnecessary decoupling of the client, receiver, and invoker. Decoupling is desirable when there are logical behavioral distinctions between the objects in a system, and in the Command pattern, decoupling is based on roles. In contrast, in the Resource-Operation design, the Operation class encapsulates behavior of the resource itself but is tailored for (although not limited to) use in systems of objects that must exhibit transactional properties. For objects that require transactional behavior, the Resource-Operation design results in more concise and maintainable implementations than the Command pattern.

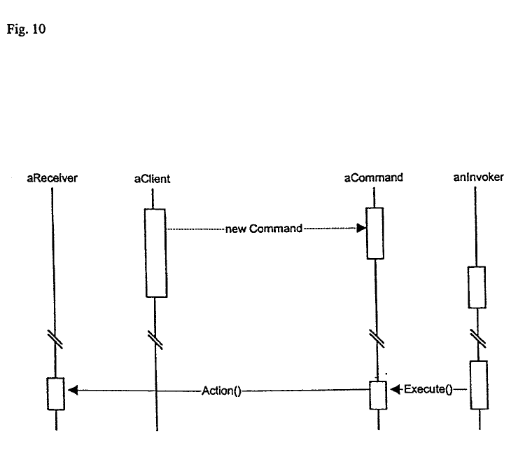

The sequence of activities of the Command pattern is illustrated in FIG. 10 (see Gamma, et al. at 237). The interactions of the Resource-Operation design illustrated in FIG. 4 are substantially simpler than those of the Gamma Command pattern illustrated in FIG. 10. The Resource-Operation design eases the implementation of a single object, and does not require the larger number of entities needed to support the roles and collaborations of the Command pattern.

Unlike the Gamma Command pattern, a client-invoker-receiver relationship is preferably not present in the Resource-Operation design. The Gamma Command pattern is motivated by the need to issue requests to objects without knowing anything about the operation being requested or the receiver of the request, and therefore the Command pattern decouples the object that causes an operation to be performed from the object that knows how to perform the operation. The Command pattern only specifies a binding between a command and a receiver.

In contrast, in transactional operations that create new objects, the new object is implicitly bound to the object implementing the operation. And (excepting operations that result in new objects being created) the transactional Operation object is preferably only permitted to modify (directly or otherwise) the object that created it. The Operation object in the Resource-Operation design may use services and knowledge inherent in the Resource object in performing the operation the Operation object encapsulates.

Further, because of the decoupling between client and receiver, the Command pattern does not provide mechanisms for obtaining return values, an essential part of many transactional operations. As described above, the Resource-Operation design supports more than one mechanism for obtaining return values.

Unlike the Resource-Operation design, the Gamma Command pattern executes a command after the command has been stored by the invoker (see Gamma figure at 237). As described above, this can cause problems in a transactional environment as execution of any part of an operation may cause the rollback. It is therefore important to execute the operation before recording it in any rollback sequence.

What is claimed:

1. A data storage device comprising data representing one or more computer programs that perform an operation that causes a reversible change on the state of a resource object, comprising:
a resource object encapsulating computer program logic, the resource object being configured to respond to a request to perform an operation that changes the state of the resource object by creating an instance of a class encapsulating the operation and a method for reversing the effects of the operation on the state of the resource object, requesting the instance to perform the operation, and storing the instance in a data structure;
the resource object being further configured to respond to a request to undo the operation by calling the method for reversing the effects of the operation.

2. The data storage device of claim 1, wherein the class encapsulating the operation is a subclass of a base class, the base class having an interface for performing an operation encapsulated by an instance of the base class, and an interface for reversing the effects of the operation encapsulated by the base class.

3. The data storage device of claim 1, wherein the resource object is an instance of a subclass of a base resource class having an interface for managing operations and reversing the effects of operations.

4. The data storage device of claim 3, wherein the class encapsulating the operation is a subclass of a base operation class, the base operation class having at least one interface configured to respond to an interface of the base resource class.

5. The data storage device of claim 1, wherein the instance is configured to return a value in response to a call to perform the operation encapsulated by the instance.

6. The data storage device of claim 1, wherein the class encapsulating the operation defines an accessor method that, when called, provides a value set by the instance when the operation encapsulated by the class is performed.

7. The data storage device of claim 1, wherein the class encapsulating the operation defines a non-private variable to store a value set by the instance when the operation encapsulated by the class is performed.

8. The data storage device of claim 1, wherein the instance is configured to receive a variable with a call to perform the operation encapsulated by the instance and to set the value of the variable when the operation encapsulated by the class is performed.

9. The data storage device of claim 1, wherein the instance is stored after the instance has performed the operation.

10. The data storage device of claim 1, wherein the resource is configured to receive a request to commit a transaction, and to release resources associated with the instance in response to the request to commit.

11. The data storage device of claim 1, wherein the instance is created by a factory object.

12. The data storage device of claim 9 wherein the instance is stored in a list.

13. A method for executing one or more computer programs to perform an operation and subsequently reverse the effects of the operation, comprising the steps of:
providing a resource object encapsulating the computer program logic;
sending an electronic request to the resource object to perform an operation that changes the state of the resource object;
the resource object creating an instance of a class encapsulating the operation and a method for reversing the effects of the operation on the state of the resource object;
requesting the instance to perform the operation;
storing the instance in a data structure;
sending an electronic request to the resource object to reverse the effects of the operation;
the resource operation calling the method for reversing the effects of the operation and deleting the stored instance.

14. The method of claim 13, wherein the class encapsulating the operation is a subclass of a base class, the base class having an interface for performing an operation encapsulated by an instance of the base class, and an interface for reversing the effects of the operation encapsulated by the base class.

15. The method of claim 13, wherein the resource object is an instance of a subclass of a base resource class having an interface for managing operations and reversing the effects of operations.

16. The method of claim 14, wherein the class encapsulating the operation is a subclass of a base operation class, the base operation class having at least one an interface configured to respond to an interface of the base resource class.

17. The method of claim 13, wherein the instance is configured to return a value in response to a call to perform the operation encapsulated by the instance.

18. The method of claim 13, wherein the class encapsulating the operation defines an accessor method that, when called, provides a value set by the instance when the operation encapsulated by the class is performed.

19. The method of claim 13, wherein the class encapsulating the operation defines a non-private variable so store a value set by the instance when the operation encapsulated by the class is performed.

20. The method of claim 13, wherein the instance is configured to receive a variable with a call to perform the operation encapsulated by the instance and to set the value of the variable when the operation encapsulated by the class is performed.

21. The method of claim 13, wherein the instance is stored after the instance has performed the operation.

22. The method of claim 13, wherein the resource is configured to receive a request to commit a transaction, and to release resources associated with the instance in response to the request to commit.

23. The method of claim 13, wherein the instance is created by a factory object.

24. The method of claim 21, wherein the instance is stored in a list.

25. A data storage device comprising data representing a transactional resource, comprising:
a transactional resource object encapsulating computer program logic, the resource object being configured for inclusion in a transaction; and
the transactional resource object being further configured to respond to a request to perform one or more operations that change the state of the resource object by, for each of the one or more operations: creating an instance of a class encapsulating the operation and a method for reversing the effects of the operation on the state of the resource object, requesting the instance to perform the operation, and storing the instance in a data structure;
the transactional resource object being further configured to respond to a request to rollback the transaction by retrieving each instance, and invoking on each instance the method for reversing the effects of the operation encapsulated by that instance on the state of the resource object.

26. The data storage device of claim 25, wherein the transactional resource object is further configured to receive a request to prepare to commit the transaction, and to provide in response a message indicating whether the transactional resource object is prepared to commit the transaction.

27. The data storage device of claim 25, wherein the transactional resource is further configured to store the instance after the instance has been executed.

28. The data storage device of claim 26, wherein the transactional resource is further configured to store the instance in a list.

29. The data storage device of claim 25, wherein the transactional resource object is further configured to invoke the method of reversing the effects of the operation encapsulated by each instance in a sequence that is the reverse of the sequence in which each instance was requested to perform the operation encapsulated by the instance.

30. A data storage device comprising data representing one or more computer programs that perform an operation that causes a reversible change on the state of a resource object, comprising:
a resource module comprising computer program logic, the resource module being configured to respond to a request to perform an operation that changes the state of the resource module by creating an instance of a module comprising the operation and a method for reversing the effects of the operation on the state of the resource module, requesting the instance to perform the operation, and storing the instance in a data structure;
the resource module being further configured to respond to a request to undo the operation by calling the method for reversing the effects of the operation.

31. The data storage device of claim 30, wherein the instance is configured to return a value in response to a call to perform the operation.

32. The data storage device of claim 30, wherein the instance defines an method that, when called, provides a value set by the instance when the instance performs the operation.

33. The data storage device of claim 30, wherein the instance defines a non-private variable to store a value set by the instance when the operation is performed.

34. The data storage device of claim 30, wherein the instance is configured to receive a variable with a call to perform the operation and to set the value of the variable when the operation is performed.

35. The data storage device of claim 30, wherein the instance is stored after the instance operation is performed.

36. The data storage device of claim 30, wherein the resource module is configured to receive a request to commit a transaction, and to release resources associated with the instance in response to the request to commit.

37. The data storage device of claim 35 wherein the instance is stored in a list.
